(19) United States
(12) Patent Application Publication
(10) Pub. No.: US 2021/0150744 A1
(43) Pub. Date: May 20, 2021

(54) SYSTEM AND METHOD FOR HYBRID DEPTH ESTIMATION

(71) Applicant: OLYMPUS CORPORATION, Hachioji-shi, Tokyo (JP)

(72) Inventors: Masao SAMBONGI, San Jose, CA (US); Kosei TAMIYA, Tokyo (JP)

(73) Assignee: OLYMPUS CORPORATION, Hachioji-shi, Tokyo (JP)

(21) Appl. No.: 16/954,393

(22) PCT Filed: Dec. 20, 2017
(86) PCT No.: PCT/US2017/067534

§ 371 Date: Jun. 16, 2020

(51) Int. Cl. G06T 7/593; H04N 13/271; H04N 13/254; H04N 13/128

(52) U.S. Cl. CPC G06T 7/593; H04N 13/271; H04N 13/254; H04N 2013/0081; G06T 2207/10028; G06T 2207/10012; G06T 2207/20221; H04N 13/128

(57) ABSTRACT

An image acquisition device includes a first image sensor configured to acquire one or more first images, a second image sensor configured to acquire a set of polarized images, and an image processor. The image processor is configured to perform operations including receiving the one or more first images from the first image sensor, determining, based on the one or more first images, a first depth estimate of a feature appearing in the one or more first images, determining a reliability of the first depth estimate, receiving the set of polarized images from the second image sensor, determining, based on the set of polarized images, a second depth estimate of the feature, and determining a hybrid depth estimate corresponding to the first depth estimate or the second depth estimate. The hybrid depth estimate is selected based on the reliability of the first depth estimate.

### FIELD OF THE INVENTION

Embodiments of the present disclosure relate generally to imaging systems for depth estimation and more particularly to imaging systems for hybrid depth estimation.

### BACKGROUND

Imaging systems in the field of the invention generally rely on the principle of triangulation. One implementation of this principle involves acquiring images from two locations where an effective aperture for pixels in the two images is small relative to the separation between the two locations. (The effective aperture refers to the portion of a physical aperture that contains all of the rays that reach the active part of a pixel.) This implementation is called stereo vision and is often implemented with two separate cameras and lenses. To perform triangulation, a correspondence is made between the two images to determine a position of features within both images. When the positions are offset from one another, the amount of offset may be used to determine the 3-dimensional location of the feature, including the depth of the feature.

Depth estimates obtained using such techniques are useful for a variety of applications. For example, depth estimates may be used to obtain a three dimensional map of a site or area of interest, such as a construction site, a room, an anatomical region, and/or the like. Depth estimates may also be used to form three dimensional models of objects for applications such as three-dimensional printing or for archival purposes. Depth estimates may also be used by cinematographers, photographers, or other artists to form three-dimensional images or video.

Accordingly, it would be desirable to develop improved imaging systems and methods for estimating the depth of an object.

### SUMMARY OF THE INVENTION

According to some embodiments, an image acquisition device may include a first image sensor configured to acquire one or more first images, a second image sensor configured to acquire a set of polarized images, and an image processor. The image processor may be configured to perform operations including receiving the one or more first images from the first image sensor, determining, based on the one or more first images, a first depth estimate of a feature appearing in the one or more first images, determining a reliability of the first depth estimate, receiving the set of polarized images from the second image sensor, determining, based on the set of polarized images, a second depth estimate of the feature, and determining a hybrid depth estimate corresponding to the first depth estimate or the second depth estimate. The hybrid depth estimate is selected based on the reliability of the first depth estimate.

According to some embodiments, a system may include a non-transitory memory and one or more hardware processors configured to read instructions from the non-transitory memory and perform operations. The operations may include receiving one or more first images from a first image sensor, determining, based on the one or more first images, a first depth estimate of a feature appearing in the one or more first images, identifying the first depth estimate as a hybrid depth estimate, and determining a reliability of the first depth estimate. When the reliability of the first depth estimate is below a predetermined threshold the operations may further include receiving a set of polarized images from a second image sensor, determining, based on the set of polarized images, a second depth estimate of the feature, and replacing the hybrid depth estimate with the second depth estimate.

According to some embodiments, a method may include receiving a first phase image and a second phase image from a phase detection sensor, determining, based on the first phase image and the second phase image, a phase-based depth estimate of a feature appearing in the first and second phase images, determining a reliability of the phase-based depth estimate, receiving a set of polarized images from a polarized image sensor, determining, based on the set of polarized images, a polarization-based depth estimate of the feature, and determining a hybrid depth estimate corresponding to the phase-based depth estimate or the polarization-based depth estimate. The hybrid depth estimate is selected based on the reliability of the phase-based depth estimate.

### BRIEF DESCRIPTION OF THE DRAWINGS

These and other aspects and features of the present disclosure will become apparent to those ordinarily skilled in the art upon review of the following description of specific embodiments in conjunction with the accompanying figures, wherein:

FIG. 1 is a simplified diagram of a depth estimation system according to some embodiments;

FIG. 2 is a simplified diagram of a phase detection sensor according to some embodiments;

FIG. 3 is a simplified diagram of a polarized image sensor according to some embodiments;

FIG. 4 is a simplified diagram of a phase detection and polarized image sensor in an interleaved configuration according to some embodiments;

FIG. 5 is a simplified diagram of a method for estimating depth using a stereo matching technique according to some embodiments;

FIG. 6 is a simplified diagram of a method for estimating depth using a polarized image sensor according to some embodiments;

FIG. 7 is a simplified diagram of a method for estimating depth using a hybrid depth estimation according to some embodiments;

FIGS. 8A-8D are simplified diagrams illustrating the use of a cost function to determine reliability according to some embodiments; and

FIGS. 9A-9C are simplified diagrams illustrating hybrid depth estimation according to some embodiments.

### DETAILED DESCRIPTION

Embodiments of the present disclosure will now be described in detail with reference to the drawings, which are provided as illustrative examples of the disclosure so as to enable those skilled in the art to practice the disclosure. The drawings provided herein include representations of devices and device process flows which are not drawn to scale. Notably, the figures and examples below are not meant to limit the scope of the present disclosure to a single embodiment, but other embodiments are possible by way of interchange of some or all of the described or illustrated elements. Moreover, where certain elements of the present disclosure can be partially or fully implemented using known components, only those portions of such known components that are necessary for an understanding of the present disclosure will be described, and detailed descriptions of other portions of such known components will be omitted so as not to obscure the disclosure. In the present specification, an embodiment showing a singular component should not be considered limiting; rather, the disclosure is intended to encompass other embodiments including a plurality of the same component, and vice-versa, unless explicitly stated otherwise herein. Moreover, inventors do not intend for any term in the specification or claims to be ascribed an uncommon or special meaning unless explicitly set forth as such. Further, the present disclosure encompasses present and future known equivalents to the known components referred to herein by way of illustration.

There are a variety of ways to acquire depth images and/or depth maps of a scene. Active methods send light from imaging equipment into the scene and measure the response. One active technique is time of flight imaging that measures the amount of time required for light to travel into the scene and return to the imaging system. Another technique is structured light where some type of projector is used to illuminate the scene with light patterns such as sinusoidal or squares waves, random dots, or various other patterns. Through triangulation using the projector and an image captured by an imaging system, the depth is estimated. Both time of flight and structured light require lighting systems with complex components. These components are typically expensive, prone to breaking or misalignment, and demand significant space and additional equipment for mechanical and electrical support.

Some imaging systems can measure depth maps of a scene through multiple exposures including video recording. Techniques include when the camera is moved through different positions or the camera acquires multiple images each with different focal settings. These systems are typically limited to scenes that are static since movement within the scene may interfere with depth estimation.

Other depth estimation techniques include shape from shading and photometric stereo, which use light coming from known direction(s) and estimate depth by analyzing the intensity of light captured by an image system to determine the relative shape of objects in the scene. Shape from shading generally uses a single image, whereas photometric stereo uses multiple images each captured under illumination from a different direction. These techniques assume the light is approximately collimated without any significant falloff as it passes through the scene. This assumption often requires use of large light sources placed relatively far from the scene. This assumption also results in estimation of only the relative shape of the surface while the absolute distance of points or objects in the scene is not possible. Additionally, shape from shading generally requires a constant or known albedo (overall object brightness), which is not practical for nearly all natural objects. Shape from shading and photometric stereo generally assume objects are Lambertian, which means they reflect light equally in all directions. Again this is not practical for many natural objects.

Another depth estimation technique involves capturing two images where the image sensing unit remains stationary and the scene is illuminated from illumination unit or units that are placed at different distances (“near” and “far”) from the scene. The distance is estimated as

$$= \frac{Δ}{\sqrt{\frac{{m}_{1}}{{m}_{2}}} - 1}$$

where [symbol] represents the estimated depth of a point of interest from the first position of illumination unit, Δ represents the distance between the near and far positions of the illumination unit or units, and m₁ and m₂ represent the measured intensities of the point of interest in the first and second images corresponding to the first and second positions, respectively. This technique generally is able to estimate depth using a compact system that includes a single imaging sensing unit and illumination unit and also can operate reliably on regions of the scene with little or no contrast. However, this technique provides an accurate depth estimate for only a single point of the scene that lies on the line connecting the positions of the illumination units. Significant errors are introduced for points away from this line. The systematic depth error results in estimates being noticeably distorted, except when the observed scene is contained within a small cone emanating from the position of the illumination unit that is centered about the line connecting the positions of the illumination unit. Therefore either the region of the scene with accurate depth estimates is limited in size by such a cone or the illumination units must be placed at a significant distance from the scene in order to increase the size of the cone.

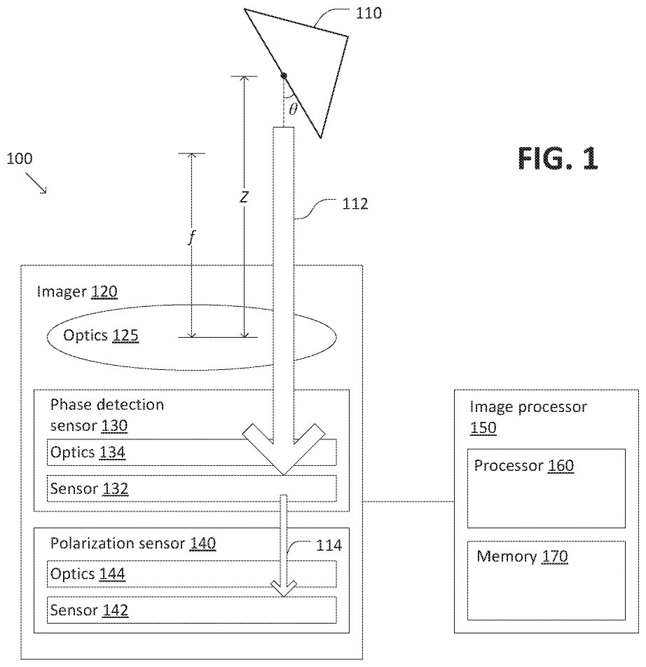

FIG. 1 is a simplified diagram of a depth estimation system 100 according to some embodiments. According to some embodiments, depth estimation system 100 may be used to estimate the depth of one or more features appearing in images acquired by depth estimation system 100. For example, the features may include objects, points, a neighborhood of points, surfaces, and/or the like. In some embodiments, depth estimation system 100 may estimate the depth of one or more discrete features and/or may estimate the depth of a set of features to form 3-dimensional images and/or depth maps. In some examples, depth estimation system 100 may be used as a standalone device. In some examples, depth estimation system 100 may be incorporated into, attached to, and/or otherwise used in conjunction with various types of equipment, such as cameras, mobile devices, industrial machinery, vehicles (e.g., land, air, space, and/or water-based vehicles), biomedical devices (e.g., endoscopes), and/or the like.

For illustrative purposes, an object 110 is depicted at a depth Z from depth estimation system 100. Object 110 emits, reflects, and/or otherwise produces illumination 112 that is captured by depth estimation system 100. In some embodiments, illumination 112 may include various types of electromagnetic radiation, such as visible light, ultraviolet radiation, infrared radiation, and/or any combination thereof. In some embodiments, object 110 may be passively illuminated by ambient light and/or actively illuminated by an illumination source, such as a camera flash (not shown). In some examples, object 110 may itself be a source of illumination 112. As depicted in FIG. 1, illumination 112 is reflected off object 110 at an angle of reflection θ.

Imager 120 acquires images by converting incident electromagnetic radiation, such as illumination 112, into electronic signals. For example, imager 120 may include one or more image sensors that convert electromagnetic radiation into electronic signals by photoelectric conversion.

In some embodiments, imager 120 may include two or more image sensors that generate images from which depth information may be extracted. In general, the two or more image sensors each provide the depth information using different mechanisms or modalities, each of which may have different strengths and/or limitations. For example, as depicted in FIG. 1, imager 120 includes a first, phase detection sensor 130 and a second, polarized image sensor 140. Techniques for extracting depth information using phase detection sensor 130 and polarized image sensor 140 are described in further detail below. It is to be understood that phase detection sensor 130 and polarized image sensor 140 are merely examples, and that imager 120 may additionally or alternately include other types of image sensors from which depth information may be extracted, such as stereo cameras, imaging systems that use active methods (e.g., time of flight and/or structured light), multiple exposure systems (e.g., video capture), and/or the like.

In some embodiments, imager 120 may include various additional image sensors for purposes other than depth estimation. For example, imager 120 may include a third image sensor for acquiring images in a different imaging modality than phase detection sensor 130 and/or polarized image sensor 140 (e.g., a non-phase and/or non-polarization imaging modality). In some examples, the third image sensor may acquire conventional black-and-white and/or color images, thermal images, infrared images, and/or the like. In some embodiments, imager 120 may additionally include electronic components for processing the electronic signals generated by the image sensors, such as amplifiers, analog to digital (A/D) converters, image encoders, control logic, memory buffers, and/or the like. Relative to phase detection sensor 130 and/or polarized image sensor 140, the additional electronic components may be placed in a separate module, in the same package, on the same chip, on the backside of a chip, and/or the like.

In some examples, imager 120 may include imaging optics 125 for forming images on phase detection sensor 130 and/or polarized image sensor 140. For example, imaging optics 125 may include one or more lenses, mirrors, beam splitters, prisms, apertures, color filters, polarizers, and/or the like. In some examples, imaging optics 125 may define a focal length f of imager 120, which corresponds to the depth at which a particular feature is in focus. The focal length f of imager 120 may be fixed and/or adjustable, e.g., by moving one or more lenses of imaging optics 125. In some examples, imaging optics 125 may define various other optical parameters associated with imager 120, such as an aperture diameter.

In some embodiments, phase detection sensor 130 and/or polarized image sensor 140 may include respective sensor layers 132 and/or 142. In some examples, sensor layers 132 and/or 142 may include a plurality of pixels, such as an array of pixels. For example, sensor layers 132 and/or 142 may include a charge coupled device (CCD) sensor, active pixel sensor, complementary metal oxide semiconductor (CMOS) sensor, N-type metal oxide semiconductor (NMOS) sensor and/or the like. According to some examples, sensor layers 132 and/or 142 may be implemented as a monolithic integrated sensor, and/or may be implemented using a plurality of discrete components.

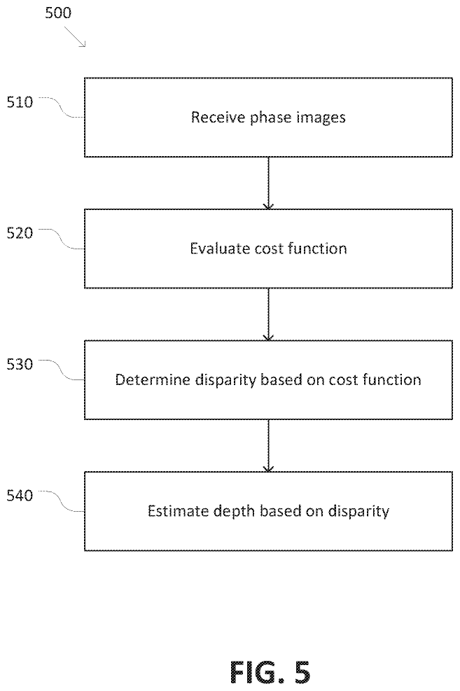

Phase detection sensor 130 captures two or more phase images in which features are offset in different directions based on the depth of a feature relative to the focal length f of imager 120. For example, the phase images may include a “left” image, in which a feature is offset to the left when the depth is less than the focal length f and to the right when the depth is greater than f. The phase images may further include a “right” image in which the feature is offset in the opposite direction relative to the “left” image. That is, the feature is offset to the right when the depth is less than f and to the left when the depth is greater than f. As depicted in FIG. 1, the depth Z of object 110 is greater than f, in which case object 110 will appear shifted to the right in the “left” image and to the left in the “right” image. Consequently, the value of Z may be estimated using stereo matching techniques based on the phase images, as will be discussed in greater detail below with reference to FIG. 5. More broadly, the phase images may include a first image, in which a feature is offset to in a first direction when the depth is less than the focal length f and in a different direction when the depth is greater than f. The phase images may further include a second image in which the feature is offset in another direction relative to the first image.

In some embodiments, phase detection sensor 130 may include phase detection optics 134 for forming the two or more phase images captured by sensor 132. For example, phase detection optics 134 may include one or more lenses (e.g., microlenses over each pixel of sensor layer 132), apertures (e.g., apertures forming left and/or right windows over each pixel of sensor layer 132), and/or the like. Illustrative embodiments of phase detection sensor 130 are described in further detail in U.S. Pat. No. 8,605,179, entitled “Image Pickup Apparatus,” and U.S. Pat. No. 8,902,349, entitled “Image Pickup Apparatus,” which are hereinafter incorporated by reference in their entirety.

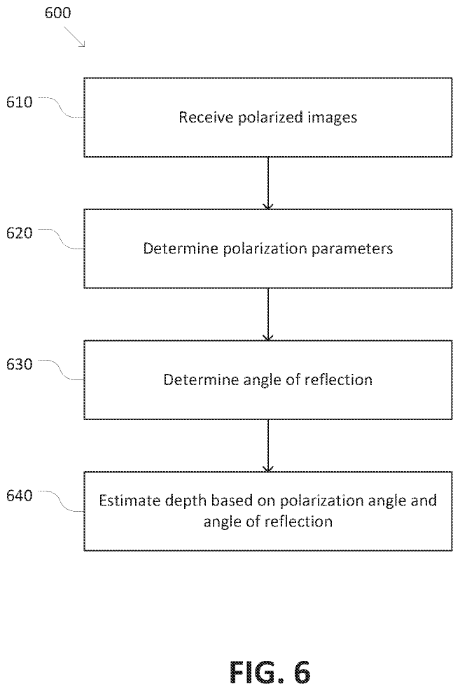

Polarized image sensor 140 captures a plurality of polarized images, each image corresponding to a particular polarization component of illumination 112. Differences among the polarized images may be used to determine the polarization angle and degree of polarization of illumination 112, which in turn may be used to determine the angle at which illumination 112 is reflected from a feature. Consequently, depth information may be extracted from the polarized images by analyzing spatial variations in the reflection angle, as will be discussed in greater detail below with reference to FIG. 6.

In some embodiments, polarized image sensor 140 may include polarization optics 144 for forming the three or more polarized images captured by sensor 142. For example, polarization optics 144 may include a layer of polarizers (e.g., a set of polarizers arranged over each pixel of sensor layer 142). Illustrative embodiments of polarized image sensor 140 are described in further detail in U.S. Pat. Publ. No. 2016/0163752, entitled “Image-Acquisition Device,” which is hereinafter incorporated by reference in its entirety.

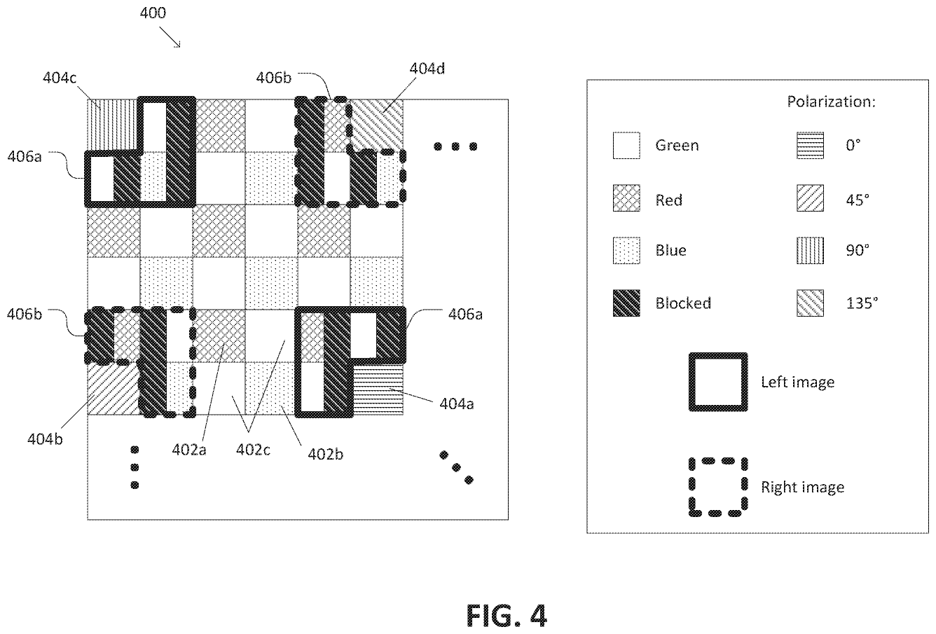

As depicted in FIG. 1, phase detection sensor 130 and polarized image sensor 140 are arranged in a stacked or serial configuration. That is, polarized image sensor 140 is at least partially covered by phase detection sensor 130. Accordingly, polarized image sensor 140 receives transmitted illumination 114, which corresponds to a portion of illumination 112 that is transmitted through phase detection sensor 130 without being absorbed, reflected, and/or the like. In some embodiments, the stacked configuration may provide a compact form factor for imager 120. However, it is to be understood that a wide variety of additional and/or alternative configurations are possible. For example, phase detection sensor 130 and polarized image sensor 140 (and/or one or more image sensors operating in a different imaging modality) may be arranged in an interleaved configuration, in which phase detection sensor 130 and polarized image sensor 140 (and/or the one or more image sensors operating in a different imaging modality) are formed using different pixels of a single sensor layer. An example of phase detection sensor 130 and polarized image sensor 140 in an interleaved configuration is depicted in FIG. 4. In some embodiments, phase detection sensor 130 and polarized image sensor 140 may be arranged in parallel or otherwise placed in separate locations (e.g., side-by-side, or otherwise in a configuration that is neither stacked nor interleaved). For example, one or more beam splitters may be used to direct illumination 112 onto phase detection sensor 130 and polarized image sensor 140.

Depth estimation system 100 includes an image processor 150 that is communicatively coupled to imager 120. According to some embodiments, image processor 150 may be coupled to imager 120 and/or various other components of depth estimation system 100 using a local bus and/or remotely coupled through one or more networking components. Accordingly, image processor 150 may be implemented using local, distributed, and/or cloud-based systems and/or the like. In some examples, image processor 150 may include a processor 160 that controls operation and/or execution of hardware and/or software. Although only one processor 160 is shown, image processor 150 may include multiple processors, CPUs, multi-core processors, field programmable gate arrays (FPGAs), application specific integrated circuits (ASICs), and/or the like. Processor 160 is coupled to a memory 170, which may include one or more types of machine readable media. Some common forms of machine readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read. Processor 160 and/or memory 170 may include multiple chips in multiple packages, multiple chips in a single package (e.g., system-in-package (SIP)), and/or a single chip (e.g., system-on-chip (SOC)). In some examples, one or more components of image processor 150, such as processor 160 and/or memory 170 may be embedded within imager 120. For example, various components of depth estimation system 100, such as sensor layers 132 and/or 144, processor 160, and/or memory 170 may be integrated in a single package and/or on a single chip.

As will be discussed, image processor 150 may be configured to perform depth estimation based on image data received from imager 120. In some examples, the image data received from imager 120 may be received in an analog format and/or in a digital format, such as a RAW image file. Similarly, the depth estimate data output by image processor 150 may be formatted using a suitable output file format including various uncompressed, compressed, raster, and/or vector file formats and/or the like. In some examples, the depth estimate data generated by image processor 150 may be stored locally and/or remotely, sent to another processor for further processing, transmitted via a network, displayed to a user of depth estimation system 100 via a display interface (not shown), and/or the like.

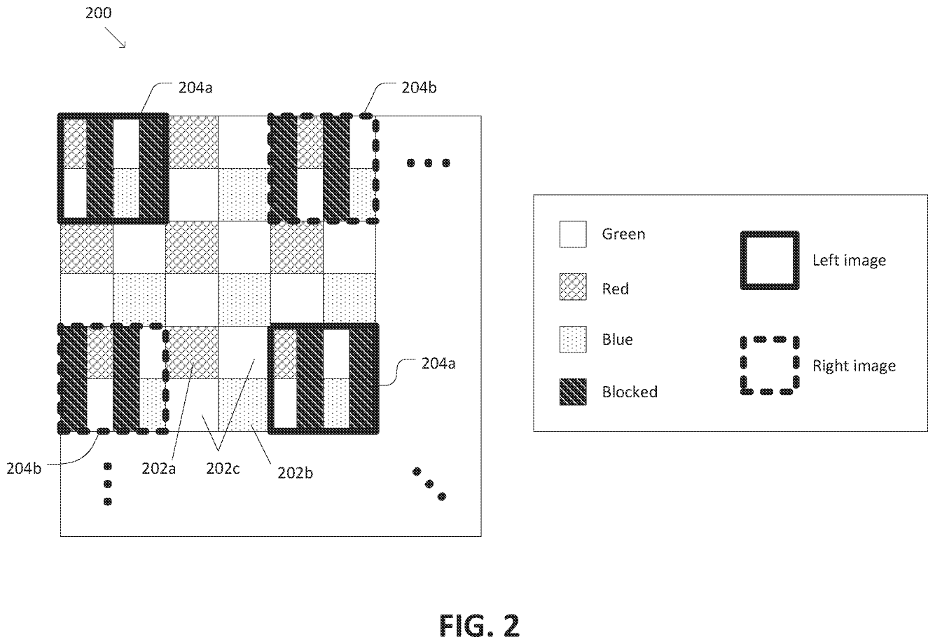

FIG. 2 is a simplified diagram of a phase detection sensor 200 according to some embodiments. In some embodiments consistent with FIG. 1, phase detection sensor 200 may be used to implement phase detection sensor 130 of imager 120. As depicted in FIG. 2, phase detection sensor 200 includes an array of pixels. As shown, a layer of one or more color filters 202 may be optionally disposed over the array of pixels to provide color resolution. In the illustrated embodiment, color filters 202a (red), 202b (blue) and 202c (green) are shown. In some embodiments, color filters 202 may form a repeating two-by-two array of four pixels in which one pixel has a red filter 202a, one pixel has a blue filter 202b, and two diagonally oriented pixels have green filters 202c.

A subset of the pixels of phase detection sensor 200 are configured to generate phase images 204. That is, in certain pixels, the right portions of the pixels are blocked to generate a first or“left” phase image 204a, whereas in other pixels, the left portions of the pixels are blocked to generate a second or “right” phase image 204b. FIG. 2 illustrates one possible pattern for interleaving pixels assigned to left image 204a, pixels assigned to right image 204b, and optional non-phase pixels (e.g., pixels that may be used to acquire images in a different imaging modality, such as conventional black and white and/or color images). However, it is to be understood that FIG. 2 is merely an example, and numerous alternative interleaving patterns of pixels may be used to acquire phase images.

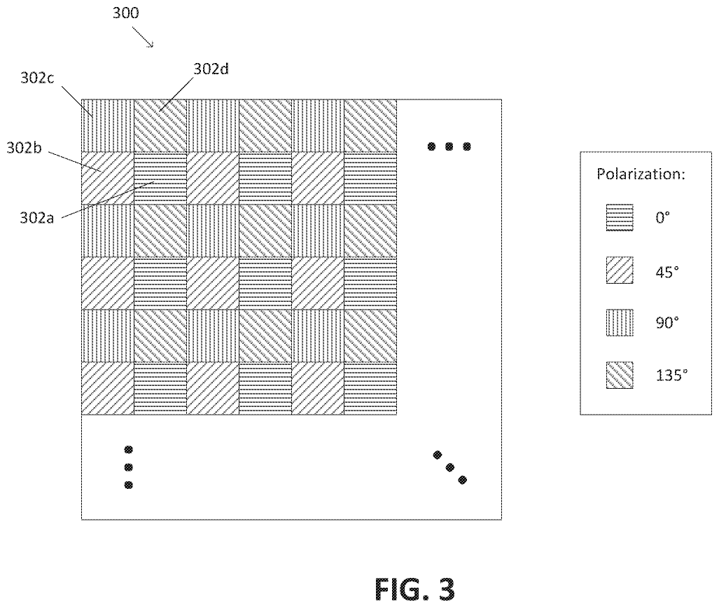

FIG. 3 is a simplified diagram of a polarized image sensor 300 according to some embodiments. In some embodiments consistent with FIGS. 1-2, polarized image sensor 300 may be used to implement polarized image sensor 140 of imager 120. In some embodiments, polarized image sensor 300 may be stacked beneath a phase detection sensor, such as phase detection sensor 200. Consistent with such embodiments, polarized image sensor 300 may form images based on illumination that is transmitted through phase detection sensor 200. In other embodiments, as mentioned above, sensor 300 may have another arrangement relative to phase detection sensor 200.

As depicted in FIG. 3, polarized image sensor 300 includes an array of pixels. The pixel density of polarized image sensor 300 may or may not match the pixel density of phase detection sensor 200, and/or may correspond to a fraction (or multiple) of the pixel density of phase detection sensor 200. For example, the pixel density of polarized image sensor 300 may be half the pixel density of phase detection sensor 200. In any event, in some embodiments, a layer of one or more polarization filters 302 is used to provide polarization resolution. Shown in FIG. 3 are 0° polarization filter 302a; 450 polarization filter 302b; 90° polarization filter 302c; and 135° polarization filter 302d. Although FIG. 3 depicts four types of polarization filters 302a-302d, it is to be understood that the polarization of incident illumination may be determined using various combinations of three or more polarization filters 302. Moreover, it is to be understood that FIG. 3 is merely an example, and the polarization filters may be interleaved and/or spaced using a wide variety of patterns.

FIG. 4 is a simplified diagram of a phase detection and polarized image sensor 400 in an interleaved configuration according to some embodiments. In some embodiments consistent with FIG. 1, sensor 400 may be used to implement phase detection sensor 130 and polarized image sensor 140 in a single sensor layer. As depicted in FIG. 4, sensor 400 includes a pixel array. As shown, a first subset of pixels have color filters 402 including color filters 402a (red), 402b (blue), and 402c (green). A second subset of color filters have polarization filters 404 including polarization filters 404a (0°), 404b (45°), 404c (90°) and 404d (135°). A third subset of pixels is configured to generate left and right phase images 406a and 406b, respectively. It is to be understood that FIG. 4 is merely an example, and the respective phase, polarized, and non-phase, non-polarized pixels (e.g., pixels having color filters 402 and/or otherwise configured to acquire images in a different imaging modality than the phase pixels and polarized pixels) may be interleaved or spaced in a wide variety of suitable arrangement. In some embodiments, the non-phase, non-polarized pixels may be omitted. Moreover, the size of various pixels may be varied. For example, each polarized pixel may be a multiple or fraction of the size of a phase pixel.

FIG. 5 is a simplified diagram of a method 500 for estimating depth using a stereo matching technique according to some embodiments. In some embodiments consistent with FIG. 1, method 500 may be performed by an image processor, such as image processor 150, that is communicatively coupled to a phase detection sensor of an imager, such as phase detection sensor 130 of imager 120.

At a process 510, first and second phase images are received. In some examples, the first and second phase images may correspond to the “left” and “right” phase images captured by the phase detection sensor, as previously discussed. Consistent with such examples, a feature appearing in both images may be offset in different directions in each of the phase images. The direction and magnitude of the offset depends on the depth of the feature relative to a focal length associated with the phase detection sensor.

One of skill in the art would appreciate that certain geometric relationships between the first and second phase images may be described using an epipolar geometry. While a detailed discussion of the epipolar geometry is beyond the scope of this disclosure, the epipolar geometry defines several geometric parameters that have standard meanings in the context of stereo matching and are referred to below, including a baseline and an epipolar line.

At a process 520, a cost function is evaluated based on the first and second phase images. In general, the cost function is a mathematical function of the first and second phase images that reaches a minimum value when the first and second phase images are aligned. In some examples, the cost function may be evaluated as a function of displacement of the second phase image relative to the first phase image along the epipolar line. For example, the cost function may be evaluated using the sum of absolute difference (SAD) technique. In some examples, the cos

$${C}_{d} ( x , y ) = {\sum }_{{x}^{′} , {y}^{′} ∈ w} {[ {I}_{l} ( {x}^{′} , {y}^{′} ) - {1}_{r} ( {x}^{′} + d , {y}^{′} ) ]}^{2}$$

where C_{d} is the cost function at a given point (x,y) in the phase images, x is a coordinate along the epipolar line, lᵢ is the left phase image, lᵣ is the right phase image, d is the displacement of the right phase image along the epipolar line, and w is a window of points around (x,y) for which the cost function is evaluated. For example, the window may correspond to an n x n box of pixels around (x,y).

At a process 530, a disparity d′(x,y) between the first and second phase images is determined based on the cost function. In some embodiments, the disparity d′(x,y) may correspond to the value of d at which the cost function is minimized for a given point (x,y). Consequently, the disparity d′ may represent the degree of misalignment between the first and second phase images (i.e., the amount of displacement d that is needed to align the first and second phase images).

At a process 540, a depth is estimated based on the disparity. In some embodiments, the depth is calculated based on the following equation:

$${Z}_{1} ( x , y ) = \frac{Bf}{{d}^{′} ( x , y )}$$

where Z₁ is the estimated depth of a feature at point (x,y), B is the length of the baseline, f is the focal length of the imager, and d′(x,y) is the disparity determined at process 530. In some examples, B may correspond to half of the aperture diameter of the imager.

FIG. 6 is a simplified diagram of a method 600 for estimating depth using a polarized image sensor according to some embodiments. In some embodiments consistent with FIG. 1, method 600 may be performed by an image processor, such as image processor 150, that is communicatively coupled to a polarized image sensor, such as polarized image sensor 140.

At a process 610, a set of polarized images is received. In some examples, the set of polarized images may include a plurality of polarized images captured by the polarized image sensor. Each of the polarized images may correspond to a different polarization direction.

At a process 620, polarization parameters are determined. In some examples, the polarization parameters may include the polarization angle and the degree of polarization. For example, the polarization angle and the degree of polarization may be determined by solving the following system of equations:

$${I}_{1} = A [ cos ( {p}_{1} + 2 ϕ ) ] + C$$

$${I}_{2} = A [ cos ( {p}_{2} + 2 ϕ ) ] + C$$

$$…$$

$${I}_{n} = A [ cos ( {p}_{n} + 2 ϕ ) ] + C$$

where lₙ is the measured intensity associated with a polarizer set at an angle pₙ, A is the amplitude, φ is the polarization angle, and C is the bias. In some embodiments consistent with FIGS. 3-4, the polarized image sensor may at least three polarizers oriented at different angles to allow the system of equations to be solved for three unknown values A, φ, and C. For example, the image sensor may include four polarizers oriented at 0°, 45°, 90°, and 135°. Accordingly, the system of equations may include four equations corresponding to p₁=0°, p₂=45, p₃=90°, and p₄=135°. In other embodiments, other numbers of polarizers corresponding to other angles may be utilized.

In some embodiments, the above system of equations may be solved analytically and/or numerically, yielding the unknown values of A, φ, and C. Accordingly, the polarization angle φ may be directly determined by solving the above equations. Similarly, the degree of polarization ρ may be determined based on the values of A and C using the following equation:

$$ρ = \frac{{I}_{max} - {I}_{min}}{{I}_{max} + {I}_{min}} = \frac{A}{C}$$

At a process 630, an angle of reflection is determined. In some examples, the angle of reflection is determined based on the value of the degree of polarization determined at process 620. For example, the relationship between the degree of polarization and the angle of reflection may be expressed using the following equation:

$$ρ ( θ ) = \frac{2 sin θtanθ \sqrt{{n}^{2} - {sin}^{2} θ}}{{n}^{2} - 2 {sin}^{2} θ + {tan}^{2} θ}$$

where θ is the angle of reflection and n is the refractive index. Notably, solving the above equation to determine the unknown value of θ may yield two possible values of θ for a given value of ρ. Accordingly, the angle of reflection may not be uniquely determined at process 630, but rather two candidate values of the angle of reflection may be determined.

At a process 640, a depth is estimated based on the polarization angle and the angle of reflection. In some embodiments, the depth may be estimated by iteratively solving the following equation:

$${Z}_{2 , n} ( x , y ) = \frac{1}{S} H ( x , y ) * {Z}_{2 , n - 1} ( x , y ) + \frac{a \cdot {ϵ}^{2}}{2 S} ( \frac{\partial p}{\partial x} + \frac{\partial q}{\partial y} )$$

where Z_{2,n} is depth estimate after the n^{th} iteration of the calculation, H is a smoothing filter, S is the sum of the smoothing filter coefficients, ϵ is the step size between pixels, p is given by tan θ cos φ, q is given by tan θ sin φ, and a is given by the following equation:

$$a = {\sum }_{u = - k}^{k} {\sum }_{v = - k}^{k} H ( u , v ) {u}^{2} = {\sum }_{u = - k}^{k} {\sum }_{v = - k}^{k} H ( u , v ) {v}^{2}$$

As discussed previously, process 630 yields two candidate values of the angle of reflection θ. Moreover, the symmetry of the polarization angle φ is such that the same results are obtained for φ±π. Consequently, a plurality of candidate depths may be estimated at process 640, corresponding to each possible value of θ and/or φ. Accordingly, reducing the depth estimate from method 600 to a single value may involve supplying additional information (e.g., contextual information) to select a value from among the plurality of candidate values that is most likely to correspond to the true depth of the feature.

Comparing the values of Z₁ and Z₂ estimated using methods 500 and 600, respectively, Z₁ is relatively simple to calculate by method 500 and generally provides a single, absolute depth estimate at a given point. However, because stereo matching involves aligning features appearing in images, Z₁ may be inaccurate and/or noisy when estimating the depth of an object or surface with little texture (e.g., few spatial variations and/or landmark features that may be used to align the phase images).

By contrast, Z₂ is generally independent of the surface texture because the depth is estimated based on the polarization of the reflected illumination rather than image alignment. Consequently, Z₂ may provide a higher accuracy and/or less noisy estimate of depth than Z₁ on a low texture surface. However, method 600 generally does not yield a single value of Z₂, but rather a plurality of candidate values, as discussed previously with respect to process 640.

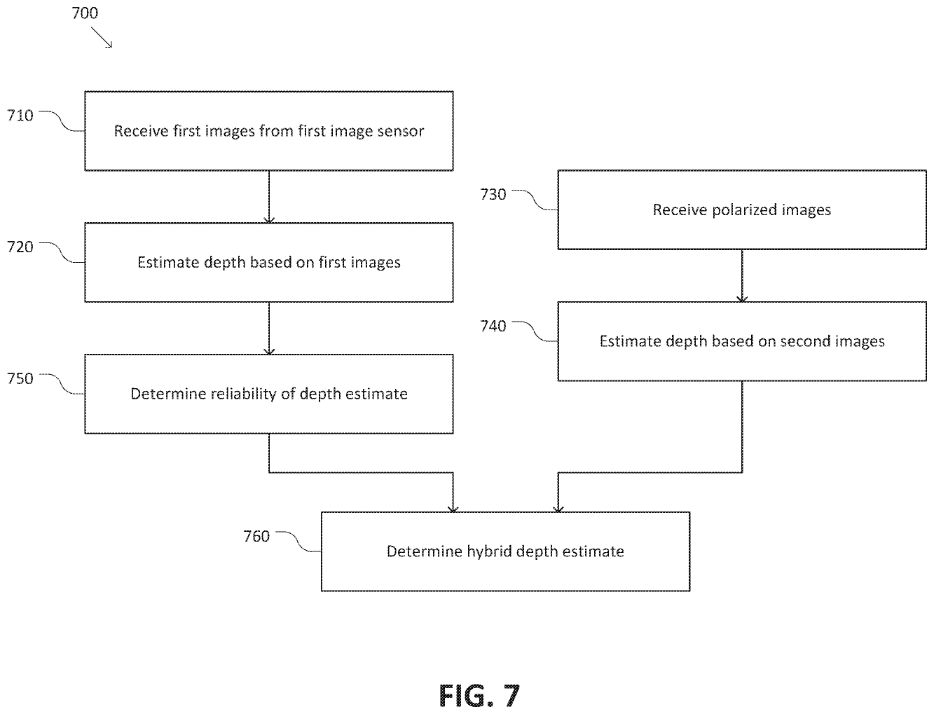

FIG. 7 is a simplified diagram of a method 700 for estimating depth using hybrid depth estimation according to some embodiments. In some embodiments consistent with FIG. 1, method 700 may be performed by an image processor, such as image processor 150, that is communicatively coupled to a phase detection sensor, such as phase detection sensor 130, and a polarized image sensor, such as polarized image sensor 140.

At a process 710, one or more first images are received from a first image sensor. In some embodiments, the one or more first images may correspond to first and second phase images received from a phase detection sensor. Consistent with such embodiments, process 710 may correspond to process 510 of method 500. However, it is to be understood that the one or more first images may correspond to various other types of images from which depth information may be extracted, such as stereo images, images corresponding to an active depth estimation method (e.g., time of flight and/or structured lighting), images captured using a moving camera and/or light source, and/or the like.

At a process 720, a first depth estimate is determined based on the first images. In some embodiments, process 720 may correspond to processes 520-540 of method 500. Consistent with such embodiments, the first depth estimate may be determined using the stereo matching technique described above. In particular, the first depth estimate may be determined using a cost function to determine a disparity between first and second phase images. However, it is to be understood that a variety of techniques may be used to determine the first depth estimate, consistent with the variety of image types that may be received from the first image sensor at process 710.

At a process 730, one or more second images are received from a second image sensor. In some embodiments, the one or more second images may correspond to a set of polarized images received from a polarized image sensor. Consistent with such embodiments, process 730 may correspond to process 610 of method 600.

At a process 740, a second depth estimate is determined based on the second images. In some embodiments, process 740 may correspond to processes 620-640 of method 600. Consistent with such embodiments, the second depth estimate may include a plurality of candidate depth estimates, such that the second depth estimate is not uniquely defined.

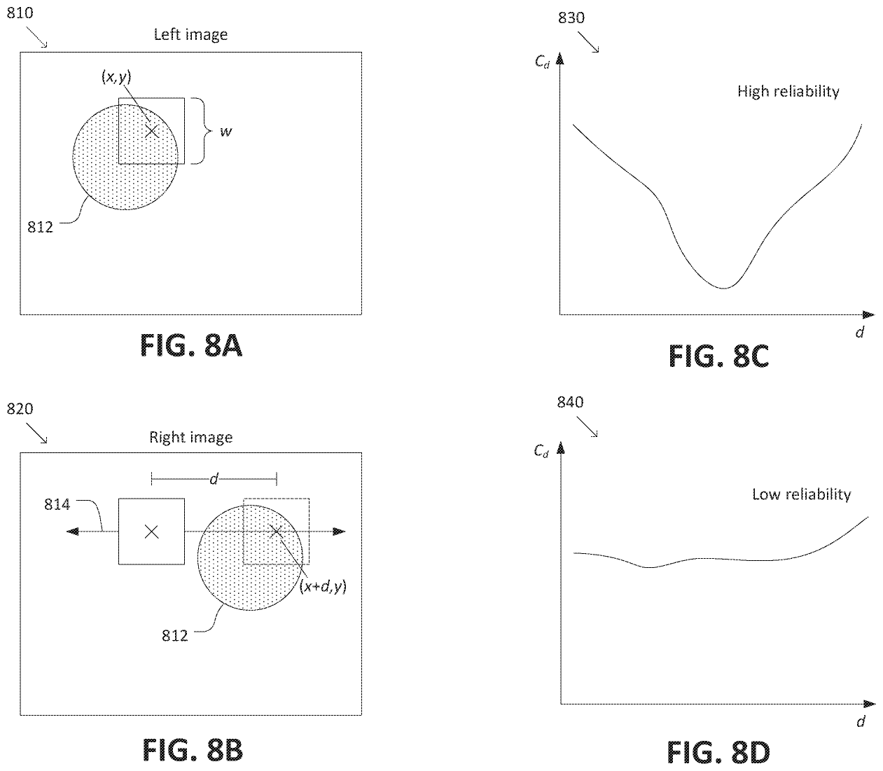

At a process 750, a reliability of the first depth estimate is determined. In some examples, the reliability may be determined based on the cost function used to determine the first depth estimate during process 720. An illustration of how the cost function may be used to determine the reliability is discussed below with reference to FIGS. 8A-8D.

FIGS. 8A-8D are simplified diagrams illustrating the use of a cost function to determine reliability according to some embodiments. FIGS. 8A and 8B depict a first or left image 810 and a second or right image 820, respectively. An object 812 appearing in left image 810 is displaced in right image 820 along an epipolar line 814. As depicted in FIGS. 8A and 8B, a window w around a point (x,y) on object 812 is used to determine the disparity between left image 810 and right image 820. In particular, the window w is shifted by a displacement d along epipolar line 814. At each value of d, a cost function C_{d} is evaluated. In some examples consistent with FIG. 5, the cost function may correspond to the cost function evaluated at process 520 of method 500. In some examples, the cost function C_{d} may reach a minimum value when the position of the window w relative to object 812 in right image 820 matches the position of the window w relative to object 812 in left image 810.

FIGS. 8C and 8D depict plots 830 and 840, respectively, of the cost function C_{d} as a function of displacement d. Plot 830 depicts a situation where the reliability is high. In particular, the cost function in plot 830 includes a relatively sharp valley with a well-defined minimum. Accordingly, a depth estimate based on the cost function plot 830 is likely to be accurate with a high degree of confidence. By contrast, plot 840 depicts a situation where the reliability is low. Unlike plot 830, the cost function plot 840 is relatively flat and does not reach an unambiguous minimum value that may be ascertained with a high degree of confidence. Consequently, a depth estimate based on the cost function in plot 840 is likely to be inaccurate and/or noisy.

Returning to process 750 of FIG. 7, it follows from the discussion of FIGS. 8A-8D that the reliability may be determined based on the shape of the cost function determined at process 720. For example, the reliability may be calculated as the inverse standard deviation of the cost function. That is, a low standard deviation describes a high reliability cost function that forms a narrow valley with a well-defined minimum value, as depicted in FIG. 8C. Meanwhile, a high standard deviation describes a low reliability cost function that is broad and/or flat, as depicted in FIG. 8D. Additionally and/or alternately, the reliability may be calculated based on the values of the cost function. For example, when one or more values of the cost function are below a predetermined threshold, the reliability may be high, whereas when no values of the cost function are below the predetermined threshold, the reliability may be low. It is to be understood that these are merely examples, and various other metrics associated with the shape of the cost function may be used for determining the reliability. Moreover, various other measures of reliability may be determined at process 750, which may or may not be associated with a cost function, consistent with the variety of image types that may be received from the first image sensor at process 710.

At a process 760, a hybrid depth estimate is determined. In some examples, the hybrid depth estimate may default to the first depth estimate determined at process 720. However, in some examples, the first depth estimate may not be sufficiently reliable. For example, the first depth estimate may be determined to be unreliable when the reliability determined at process 750 is below a predetermined threshold. Accordingly, when the reliability is below the predetermined threshold, the second depth estimate determined at process 740 may be used as the hybrid depth estimate. For example, when the second depth estimate includes a plurality of candidate depth estimate, contextual information may be used to determine which of the plurality of candidate depth estimates is likely to represent the true depth value. In some examples, the contextual information may include information associated with the first depth estimate (e.g., selecting the candidate depth estimate that is closest to the first depth estimate), the hybrid depth estimate assigned to nearby points (e.g., selecting the candidate depth estimate that is closest to the depth assigned to a neighboring pixel), and/or the like. Upon determining the hybrid depth estimate, method 700 may terminate and/or may proceed to processes 720 and/or 740 to perform hybrid depth estimation at other points in the received images.

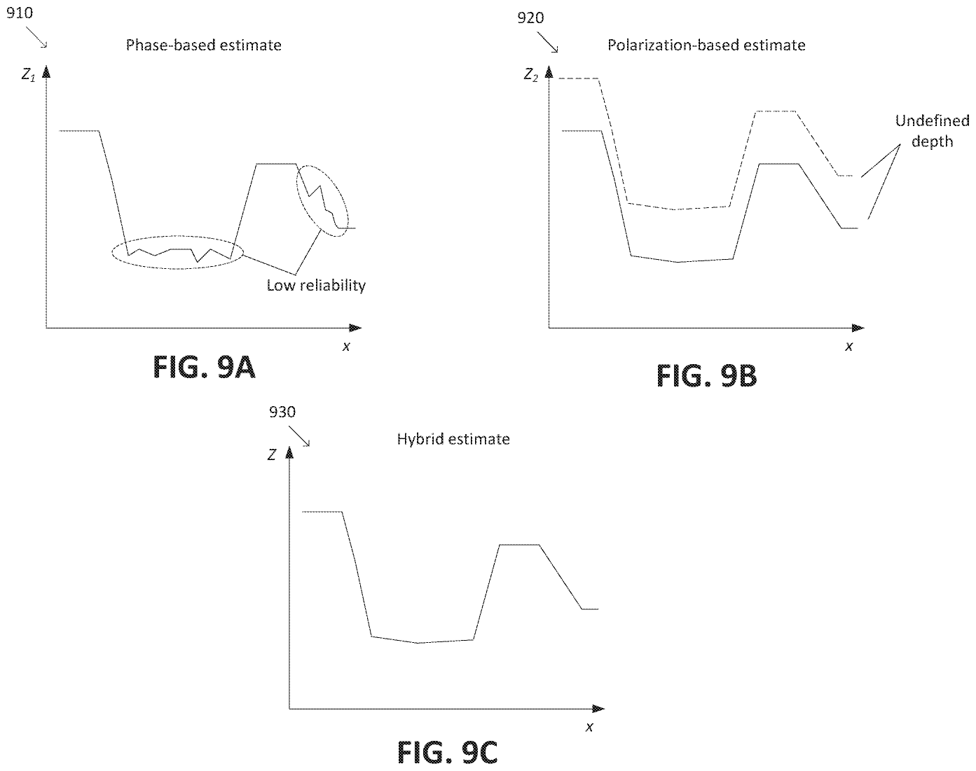

FIGS. 9A-9C are simplified diagrams illustrating hybrid depth estimation according to some embodiments. FIGS. 9A-9C depict plots 910-930, respectively, in which the depth estimate is plotted for a plurality of points along a line x. For example, the line x may correspond to a row of pixels in an image.

In plot 910, the depth estimate Z₁ corresponds to a phase-based depth estimate, such as the first depth estimate determined at process 720 of method 700. As depicted in FIG. 9A, plot 910 includes two regions of low reliability, in which the phase-based depth estimate is noisy and/or otherwise uncertain.

In plot 920, the depth estimate Z₂ corresponds to a polarization-based depth estimate, such as the second depth estimate determined at process 740 of method 700. As depicted in FIG. 9B, plot 920 does not include the two regions of low reliability that appear in process 910. However, the polarization-based depth estimate is not uniquely defined, as a plurality of candidate depth estimates may satisfy the equations solved at process 740 given the polarization information provided. Accordingly, both the phase-based estimate and polarization-based estimate may individually be insufficient to provide a highly reliable, uniquely defined depth estimate at each point along the line x.

In plot 930, the depth estimate Z corresponds to a hybrid depth estimate, such as the hybrid depth estimate determined at process 760 of process 700. As FIG. 9C illustrates, the depth estimate Z combines the advantages of the phase-based depth estimate and the polarization-based depth estimate. In particular, the low reliability, noisy portions of plot 910 have been replaced with the more robust estimates depicted in plot 920. Meanwhile, the contextual information supplied by plot 910 is used to select one of the plurality of candidate depth estimates depicted in plot 920. Consequently, the hybrid depth estimate illustrated in plot 930 provides an improved depth estimate relative to either plot 910 or plot 920 alone.

Some examples of controllers, such as image processor 150 may include non-transient, tangible, machine readable media that include executable code that when run by one or more processors may cause the one or more processors to perform the processes of methods 500, 600, and/or 700. Some common forms of machine readable media that may include the processes of methods 500, 600 and/or 700 are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Although illustrative embodiments have been shown and described, a wide range of modifications, changes and substitutions are contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. An image acquisition device comprising:
a first image sensor configured to acquire one or more first images;
a second image sensor configured to acquire a set of polarized images; and
an image processor configured to perform operations comprising:
receiving the one or more first images from the first image sensor;
determining, based on the one or more first images, a first depth estimate of a feature appearing in the one or more first images;
determining a reliability of the first depth estimate;
receiving the set of polarized images from the second image sensor;
determining, based on the set of polarized images, a second depth estimate of the feature; and
determining a hybrid depth estimate corresponding to the first depth estimate or the second depth estimate, wherein the hybrid depth estimate is selected based on the reliability of the first depth estimate.

2. The image acquisition device of claim 1, wherein the first image sensor includes a phase detection sensor.

3. The image acquisition device of claim 2, wherein determining the first depth estimate includes determining the first depth estimate using a stereo matching technique.

4. The image acquisition device of claim 3, wherein the stereo matching technique includes determining a cost function.

5. The image acquisition device of claim 4, wherein the reliability is determined based on a shape of the cost function.

6. The image acquisition device of claim 4, wherein the reliability is determined based on an inverse standard deviation of the cost function.

7. The image acquisition device of claim 1, wherein the hybrid depth estimate corresponds to the first depth estimate when the reliability of the first depth estimate is above a predetermined threshold.

8. The image acquisition device of claim 7, wherein the hybrid depth estimate corresponds to the second depth estimate when the reliability of the first depth estimate is below a predetermined threshold.

9. The image acquisition device of claim 1, wherein the second depth estimate includes a plurality of candidate depth estimates, and wherein determining the hybrid depth estimate includes selecting one of the plurality of candidate depth estimates based on contextual information.

10. The image acquisition device of claim 1, wherein the first image sensor and the second image sensor are arranged in a stacked configuration, and wherein the second image sensor acquires the set of polarized images based on illumination transmitted through the first image sensor.

11. The image acquisition device of claim 1, wherein the first image sensor and the second image sensor are arranged in an interleaved configuration.

12. The image acquisition device of claim 1, further comprising a third image sensor configured to acquire images using a different imaging modality than the first image sensor and the second image sensor.

13. The image acquisition device of claim 12, wherein the first image sensor and the third image sensor are arranged in an interleaved configuration.

14. A system comprising:
a non-transitory memory; and
one or more hardware processors configured to read instructions from the non-transitory memory and perform operations comprising:
receiving one or more first images from a first image sensor;
determining, based on the one or more first images, a first depth estimate of a feature appearing in the one or more first images;
identifying the first depth estimate as a hybrid depth estimate;
determining a reliability of the first depth estimate;
when the reliability of the first depth estimate is below a predetermined threshold:
receiving a set of polarized images from a second image sensor;
determining, based on the set of polarized images, a second depth estimate of the feature; and
replacing the hybrid depth estimate with the second depth estimate.

15. The system of claim 14, wherein the one or more first images include a first phase image and a second phase image.

16. The system of claim 15, wherein determining the first depth estimate includes evaluating a cost function expressed as follows:
$${C}_{d} ( x , y ) = {\sum }_{{x}^{′} , {y}^{′} ∈ w} {[ {I}_{l} ( {x}^{′} , {y}^{′} ) - {1}_{r} ( {x}^{′} + d , {y}^{′} ) ]}^{2}$$
where:
C_{d} is the cost function at a given point (x,y) in the first and second phase images;
x is a coordinate along an epipolar line of the first and second phase images;
lₗ is the first phase image;
lᵣ is the second phase image;
d is a displacement of the second phase image along the epipolar line; and
w is a window of points around (x,y) for which the cost function is evaluated.

17. The system of claim 16, wherein the reliability is determined based on an inverse standard deviation of the cost function.

18. The system of claim 14, wherein determining the second depth estimate includes:
determining a degree of polarization based on the set of polarized images; and
determining an angle of reflection based on the degree of polarization using a mathematical relationship expressed as follows:
$$ρ ( θ ) = \frac{2 sin θtanθ \sqrt{{n}^{2} - {sin}^{2} θ}}{{n}^{2} - 2 {sin}^{2} θ + {tan}^{2} θ}$$
where:
ρ is the degree of polarization;
θ is the angle of reflection; and
n is a refractive index.

19. A method comprising:
receiving a first phase image and a second phase image from a phase detection sensor;
determining, based on the first phase image and the second phase image, a phase-based depth estimate of a feature appearing in the first and second phase images;
determining a reliability of the phase-based depth estimate;
receiving a set of polarized images from a polarized image sensor;
determining, based on the set of polarized images, a polarization-based depth estimate of the feature; and
determining a hybrid depth estimate corresponding to the phase-based depth estimate or the polarization-based depth estimate, wherein the hybrid depth estimate is selected based on the reliability of the phase-based depth estimate.

20. The method of claim 19, further comprising determining the hybrid depth estimate for a plurality of features appearing in the first and second phase images to form a depth map.
